(19) United States
(12) Patent Application Publication
(10) Pub. No.: US 2025/0051514 A1
(43) Pub. Date: Feb. 13, 2025

(54) PROCESS FOR THE PRODUCTION OF A POLYESTER HAVING A REDUCED CRYSTALLIZATION TEMPERATURE

(71) Applicants: IFP ENERGIES NOUVELLES, Rueil-Malmaison (FR); JEPLAN, INC., Kawasaki City, Kanagawa (JP)

(72) Inventors: Guillaume BLANCKE, Rueil-Malmaison Cedex (FR); David CHICHE, Rueil-Malmaison Cedex (FR); Frederic FAVRE, Rueil-Malmaison Cedex (FR); Damien LEINEKUGEL LE COCQ, Rueil-Malmaison Cedex (FR); Adrien MEKKI-BERRADA, Rueil-Malmaison Cedex (FR)

(73) Assignees: IFP ENERGIES NOUVELLES, Rueil-Malmaison (FR); JEPLAN, INC., Kawasaki City, Kanagawa (JP)

(21) Appl. No.: 18/717,544

(22) PCT Filed: Dec. 6, 2022
(86) PCT No.: PCT/EP2022/084584

§ 371 Date: Jun. 7, 2024

(30) Foreign Application Priority Data
Dec. 10, 2021 (FR) FR2113248

(51) Int. Cl. C08G 63/80; C08G 63/183; C08G 63/685; C08G 63/85

(52) U.S. Cl. CPC C08G 63/80; C08G 63/183; C08G 63/6856; C08G 63/85

(57) ABSTRACT

The present invention relates to a process for the production of a polyester, comprising:
a) a stage of esterification of a mixture comprising a monomer A of formula 1 and a monomer B of formula 2 or a monomer A of formula 1, a monomer B of formula 2 and isophthalic acid,

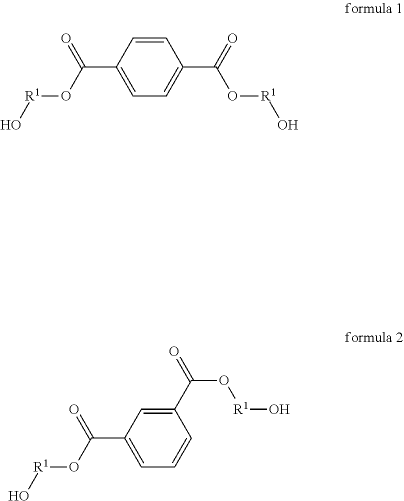

in which R¹ is chosen from the group consisting of:
—(CH₂)ₙ—, with n an integer of between 2 and 4,
—(CH₂—CHR²)—, with R² chosen from linear or branched alkyl groups comprising between 1 and 6 carbon atoms (C₁-C₆) and a phenyl group, then
b) a stage of polycondensation.

### TECHNICAL FIELD

The invention relates to a process for the production of polyester, in particular of a thermoplastic polyester, suitable in particular for bottle, packaging or coating applications, for example food container applications. More particularly, the invention relates to a process for the production of a polyester from a mixture of at least two dihydroxyl aromatic diester monomers. Very advantageously, at least one of the two dihydroxyl aromatic diester monomers results from a process for the recycling of polyesters, in particular from a process for the depolymerization of a polyester feedstock, for example comprising waste and/or post-consumption polyesters.

### PRIOR ART

The chemical recycling of polyester, in particular of polyethylene terephthalate (PET), has formed the subject of numerous studies targeted at breaking down the polyester, recovered in the form of waste, into monomers which can then be used as feedstock of a polymerization process.

The process of polymerization in particular of products resulting from the depolymerization of polyester, such as diol, diacid or diester monomers or also such as oligomers, in order to obtain PET, has also formed the subject of numerous studies.

In particular, U.S. Pat. No. 4,001,187 discloses processes for the production of high-quality PET, comprising a stage of continuous feeding of ethylene glycol and terephthalic acid into the esterification medium comprising bis(2-hydroxyethyl) terephthalate (BHET). Patent Application US 2019/0002632 provides, for its part, a process comprising the esterification of a mixture of BHET and of an aromatic polycarboxylic acid. The documents US 2019/0106567 and US2020031992 disclose processes for the preparation of respectively flame-retardant and dyed polyesters, by esterification of a bis(hydroxy)alkyl terephthalate monomer with diacid mixtures, followed by polycondensation, the diacid mixtures comprising an aromatic dicarboxylic acid, preferably terephthalic acid, and respectively a carboxyphosphinic acid and a dyed aromatic dicarboxylic acid containing a sulfonate group, for example sulfoterephthalic acid. The document US2020055982 discloses the production of a polyester polyol by polycondensation of a diol composition comprising a dihydroxyalkyl terephthalate monomer, in particular BHET, and a short-chain C₂-C₉ diol, in particular ethylene glycol or diethylene glycol, with a dicarboxylic acid, such as phthalic acid. Finally, Patent Application US 2018/0340041 provides a process for the production of a polyester by polymerization, in two reaction phases, of a mixture comprising a first diol terephthalate monomer, which is predominant in the mixture, and a second monomer consisting of 2-(2-hydroxyethoxy)ethyl 2-hydroxyethyl terephthalate (BHET-DEG), which is in the minority in the mixture, the first esterification phase being carried out at a moderate temperature.

These documents provide for the polymerization of mixtures of BHET with diol and/or carboxylic acid compounds but do not teach the preparation of polyester by reaction of said BHET, bis(2-hydroxyethyl) terephthalate, with its meta isomer, that is to say bis(2-hydroxyethyl) isophthalate, nor the way of adjusting the proportion of meta aromatic units during the esterification phase.

In the same way, the document MX 2007/004429 discloses the production of a polyester, comprising the depolymerization by glycolysis of PET flakes at atmospheric pressure in the presence of ethylene glycol in a bis(2-hydroxyethyl) terephthalate (BHET) base. The intermediate product obtained on conclusion of the depolymerization stage is filtered through a sintered filter in order to retain particles of at least 25 μm before being introduced into the polymerization reactor, in order to obtain a polyester. Patent Application WO 2017/006217 discloses the process for the preparation of a glycol-modified polyethylene terephthalate (r-GPET) comprising a stage of depolymerization of a PET in the presence of a mixture of monoethylene glycol (MEG) and of neopentyl glycol, followed directly by a stage of polymerization of the reaction effluent. Patent Application FR 3053691 describes, for its part, a process for the depolymerization of a polyester feedstock, comprising in particular from 0.1% to 10% by weight of pigments, by glycolysis in the presence of ethylene glycol. A bis(2-hydroxyethyl) terephthalate (BHET) monomer effluent, obtained after specific separation and purification stages, can feed a polymerization stage for the purpose of producing PET. Patent JP3715812 describes the production of refined BHET from PET, it being possible for the BHET obtained to be used as starting material in a process for the production of plastics. Patent EP 1 120 394 discloses the optional use of high-purity bis(2-hydroxyethyl) terephthalate (BHET) as starting material for the production of a high-quality polyester, the BHET being obtained by depolymerization of a polyester.

While they disclose the polymerization of products resulting from the depolymerization of PET by glycolysis, the documents cited do not give any information on the quality of the intermediate products resulting from the depolymerization of PET, in particular on the presence of the para and meta isomers of dihydroxyl aromatic diester monomers.

In the work by Scheirs J. and Long T. E., “Modern Polyesters: Chemistry and Technology of Polyesters and Copolyesters”, Chichester, John Wiley & Sons Ltd, 2003, p. 750 (Wiley Series in Polymer Science), the authors report that isophthalic acid (IPA) is a comonomer which affects the crystallization behaviour of PET. It is introduced into PET in amounts of up to 5 mol %, in order to suppress the crystallization behaviour during injection moulding and stretch-blow moulding, which makes it possible to obtain clear and shiny bottles. Patent Application US2020079900 confirms that, in order to provide an optical clarity acceptable for the packaging of bottles, conventional PET resins often contain a comonomer, such as isophthalic acid (IPA). The role of the comonomer is to disrupt the linearity of the PET chains, thus reducing the tendency to crystallization. The reduction in the crystallization makes it possible to improve the haze (for example, a reduced haze value) and the optical properties (for example, an increased luminosity and/or an increased transmission of visible light). Small amounts of IPA comonomer, for example from 1% to 10% by weight, make it possible to considerably modify the properties of the polymer.

However, none of the documents of the prior art provides a simple process for the production of a polyester exhibiting a formulation compatible with packaging applications and more particularly with applications of bottle type, using in particular starting materials which can result from the recycling of plastics and especially of polyesters.

### SUMMARY OF THE INVENTION

A subject-matter of the invention is a process for the production of a polyester, comprising:
a) a stage of esterification of a mixture comprising a monomer A of formula 1 and a monomer B of formula 2 or a monomer A of formula 1, a monomer B of formula 2 and isophthalic acid, in order to obtain an oligomeric intermediate,

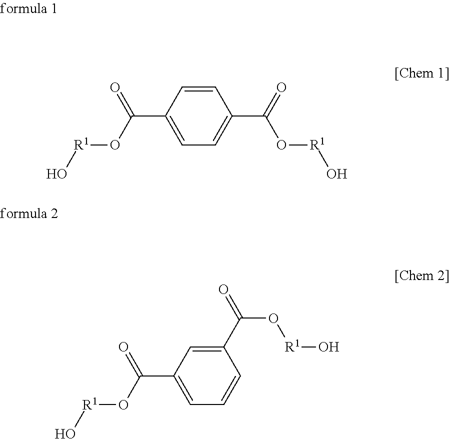

in which R¹ is chosen from the group consisting of:
—(CH₂)ₙ—, with n an integer of between 2 and 4,
—(CH₂—CHR²)—, with R² chosen from linear or branched alkyl groups comprising between 1 and 6 carbon atoms (C₁-C₆) and a phenyl group,
b) a stage of polycondensation of the oligomeric intermediate.

The present invention has the advantage of providing a simple process for the production of polyester exhibiting a content of meta units corresponding to a decreased crystallization behaviour and a decreased melting point and at least suitable for injection moulding and/or injection-blow moulding processes, thus rendering it compatible with packaging applications and more particularly with applications of bottle type. In particular, the content of meta units of the polyester, preferably of PET, obtained by using the process according to the invention is advantageously between 0.1 mol % and 10.0 mol %, preferably between 0.25 mol % and 7.0 mol %, preferentially between 0.5 mol % and 5.0 mol %, with respect to all of the elementary units of the polyester. Bottles can then be manufactured with a polyester obtained according to the process of the present invention by known injection-stretch-blow moulding processes and the bottles manufactured have a clear and transparent appearance.

Another advantage of the present invention lies in the origin of the starting materials and in particular of the dihydroxyl aromatic diester monomers, which can originate from any known source and in particular from networks for the recycling of plastics, set up in recent years by national and international organisations in order to combat plastic pollution. This is because at least one, or both, of the dihydroxyl aromatic diester monomers used to prepare the polyester according to the present invention can result from processes for the depolymerization of polyesters, such as PET, in the presence of diol or of methanol. Thus, the process according to the present invention can contribute to the recycling of polyester materials and thus to the fight against plastic pollution.

### DESCRIPTION OF THE EMBODIMENTS

According to the invention, the terms “diester monomer”, “aromatic diester monomer” and “dihydroxyl aromatic diester monomer” are interchangeable and denote monomer compounds which can be condensed with one another to form the targeted polyester. More particularly, the diester monomer according to the invention is a diester compound derived from terephthalic or isophthalic acid and from a diol, preferably from a mono- or polyalkylene glycol, preferentially a monoalkylene glycol, the term “derived” meaning, in this case, that the compound can result from the condensation of terephthalic or isophthalic acid with said diol. Thus, the diester monomer according to the invention comprises an aromatic ring doubly substituted in the para or meta position by ester groups themselves each comprising a hydroxyl group. Specific diester monomers according to the invention are in particular the monomer A of formula 1, the monomer B of formula 2 and the monomer C of formula 3:

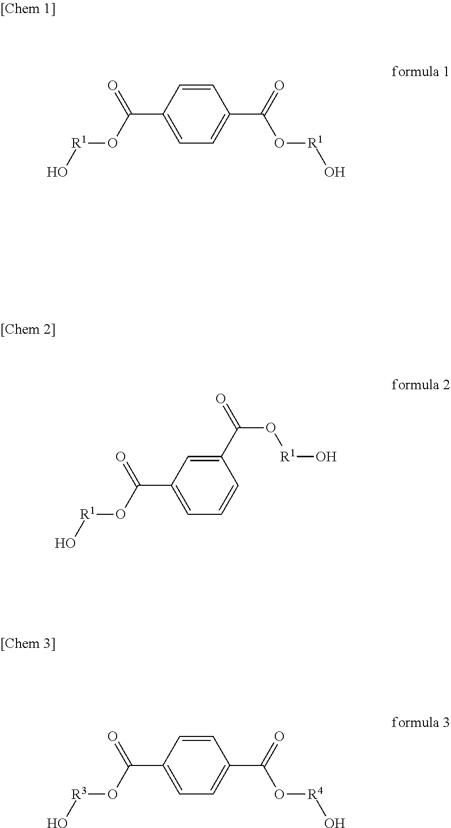

in which:
R¹ is chosen from the group consisting of:
—(CH₂)ₙ—, with n an integer of between 2 and 4, preferably equal to 2,
—(CH₂—CHR²)—, with R² chosen from linear or branched alkyl groups comprising between 1 and 6 carbon atoms (C₁-C₆), preferably between 1 and 3 carbon atoms (C₁-C₃), preferably 2 carbon atoms (C₂), and a phenyl group,
R³ is chosen from the group consisting of:
the R¹ group,
a —(CH₂)ₙ—(O—(CH₂)ₙ)ₘ— group, with m and n integers, m being of between 1 and 4, preferably equal to 1 or 2, and n being of between 2 and 4, preferably equal to 2; preferably, the —(CH₂)ₙ—(O—(CH₂)ₙ)ₘ— group is a derivative of (that is to say, results from) diethylene glycol (i.e., —CH₂—CH₂—O—CH₂—CH₂—) or a derivative of (that is to say, results from) triethylene glycol (i.e., —CH₂—CH₂—(O—CH₂—CH₂)₂—),
a —(CH₂—CH(CH₃)₂—CH₂)— group, and
a —CH₂—C₆H₁₀—CH₂— group, in which —C₆H₁₀— is advantageously a disubstituted cyclohexyl,
R⁴ is chosen from the group consisting of:
a —(CH₂)ₙ—(O—(CH₂)ₙ)ₘ— group, with m and n integers, m being of between 1 and 4, preferably equal to 1 or 2, and n being of between 2 and 4, preferably equal to 2; preferably, the —(CH₂)ₙ—(O—(CH₂)ₙ)ₘ— group is a derivative of (that is to say, results from) diethylene glycol (i.e., —CH₂—CH₂—O—CH₂—CH₂—) or a derivative of (that is to say, results from) triethylene glycol (i.e., —CH₂—CH₂—(O—CH₂—CH₂)₂—),
a —(CH₂—CH(CH₃)₂—CH₂)— group, and
a —CH₂—C₆H₁₀—CH₂— group, in which —C₆H₁₀— is advantageously a disubstituted cyclohexyl.

Very preferably, the monomer A is bis(2-hydroxyethyl) terephthalate (BHET) and the monomer B is bis(2-hydroxyethyl) isophthalate (BHEI).

According to the invention, the terms “terephthalate unit” and “para unit” are interchangeable and denote the units of the polyester or of the monomers comprising an aromatic nucleus (thus units referred to as aromatic units) and in which the aromatic nucleus is substituted in the para position.

According to the invention, the terms “isophthalate unit” and “meta unit” are interchangeable and denote the units of the polyester or of the monomers comprising an aromatic nucleus (thus units referred to as aromatic units) and in which the aromatic nucleus is substituted in the meta position.

According to the invention, the term “polyester” denotes an advantageously saturated thermoplastic polymer (in contrast to thermosetting polymers) having, as elementary repeat units, diol esters and more particularly at least alkylene terephthalate units, the alkylene ester groups of which are located at the para position on the aromatic nucleus, and alkylene isophthalate units, the alkylene ester groups of which are located at the meta position on the aromatic nucleus. Preferably, the alkylene terephthalate units are predominant in the main polymer chain, with respect to the alkylene isophthalate units, which means that the alkylene terephthalate units represent at least 60 mol %, preferably at least 80 mol %, preferentially at least 90 mol %, in a preferred way at least 95 mol %, of the elementary units present in the polymer chain, with respect to the alkylene phthalate units (that is to say, with respect to the combined alkylene terephthalate and alkylene isophthalate units). In a preferred way, the alkylene isophthalate units, which are in the minority in the main polymer chain with respect to the alkylene terephthalate units, represent between 0.1 mol % and 10.0 mol %, preferably between 0.25 mol % and 7.0 mol %, preferentially between 0.5 mol % and 5.0 mol %, of the elementary units present in the polymer chain, with respect to the alkylene phthalate units (that is to say, with respect to the combined alkylene terephthalate and alkylene isophthalate units). Thus, according to the invention, the term “polyester” is used to denote a polyalkylene terephthalate, in a chain of which alkylene isophthalate units are found. The polyester according to the invention can, for example, be polyethylene terephthalate PET, polybutylene terephthalate PBT or polytrimethylene terephthalate PTT, each of these polyesters also comprising alkylene isophthalate units, respectively ethylene isophthalate, butylene isophthalate or trimethylene isophthalate units. The polyester according to the invention can also comprise other units on its main polymer chain, such as vinyl or polyol units, according to the final properties desired for the polymer and according to the applications targeted. According to the invention, the preferred polyester is polyethylene terephthalate, also referred to simply as PET, the predominant para elementary repeat unit of which is of formula 4 and which comprises at least one minority meta elementary unit of formula 5 on the main polymer chain:

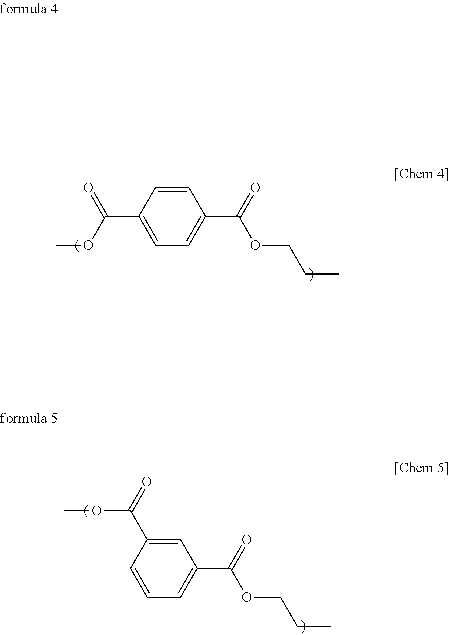

According to the invention, the terms “diol” and “glycol” are used without distinction and correspond to compounds comprising 2 hydroxyl —OH groups and preferably comprising between 2 and 12 carbon atoms, preferentially between 2 and 4 carbon atoms. The preferred diol is ethylene glycol, also referred to as monoethylene glycol or MEG.

According to the present invention, the expressions “of between . . . and . . . ” and “between . . . and . . . ” are equivalent and mean that the limiting values of the interval are included in the range of values which are described. If such is not the case and if the limiting values are not included in the range described, such information will be introduced by the present invention.

Within the meaning of the present invention, the various ranges of parameters for a given stage, such as the ranges of pressures and the ranges of temperatures, can be used alone or in combination. For example, within the meaning of the present invention, a range of preferred pressure values can be combined with a range of more preferred temperature values.

In the continuation of the text, specific embodiments of the invention may be described. They can be implemented separately or combined together, without limitation of combinations when this is technically feasible.

According to the invention, the pressures are absolute pressures and are given in MPa.

The invention thus relates to a process for the production of a polyester, comprising, preferably consisting of:
a) a stage of esterification of a mixture comprising a monomer A of formula 1 and a monomer B of formula 2 or of a mixture comprising a monomer A of formula 1, a monomer B of formula 2 and isophthalic acid (IPA), preferably in a molar ratio (meta/[meta+para]) of the aromatic units substituted in the meta position, with respect to the combined aromatic units (in particular substituted in the meta and para positions) present in the mixture, of between 0.1 mol % and 10.0 mol %, preferably between 0.25 mol % and 7.0 mol %, preferentially between 0.5 mol % and 5.0 mol %, said molar ratio corresponding more particularly to the ratio of the number of moles of monomer B and of isophthalic acid present in the mixture to the total number of moles of monomers present in the mixture and having an aromatic ring, and thus in particular the total number of moles of monomer A, monomer B and isophthalic acid, in order to obtain an oligomeric intermediate,

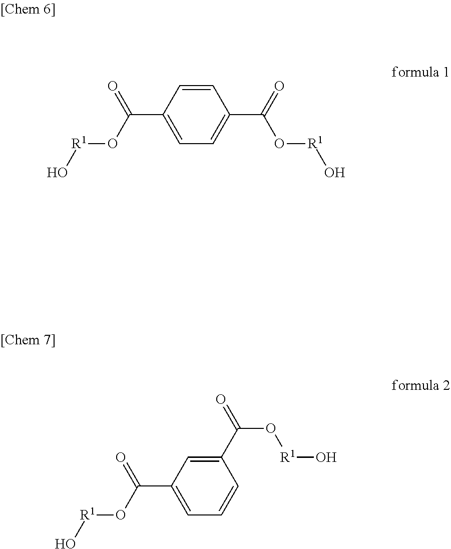

in which R¹ is chosen from the group consisting of:
—(CH₂)ₙ—, with n an integer of between 2 and 4, preferably equal to 2, such that R¹ is an ethylene group,
—(CH₂—CHR²)—, with R² chosen from linear or branched alkyl groups comprising between 1 and 6 carbon atoms (C₁-C₆), preferably between 1 and 3 carbon atoms (C₁-C₃), preferably 2 carbon atoms (C₂), and a phenyl group,
b) a stage of polycondensation of the oligomeric intermediate.

The mixture of stage a) can comprise the monomer B in a molar ratio of the monomer B, with respect to the combined monomers A and B (monomer B/[monomer A+monomer B]), of less than or equal to 10 mol %, more particularly of between 0.01 mol % and 10.0 mol %, preferably between 0.05 mol % and 7.00 mol %, in a preferred way between 0.05 mol % and 5.00 mol %. If the amount of monomer B in the mixture of stage a) is too low, in particular if the molar ratio (monomer B/[monomer A+monomer B]) of the monomer B, with respect to the combined monomers A and B present in the mixture of stage a), is less than 0.1 mol %, then the mixture of stage a) comprises isophthalic acid, in addition to the monomers A and B, so as to achieve a (meta/[meta+para]) molar ratio of between 0.1 mol % and 10.0 mol %, preferably between 0.25 mol % and 7.0 mol %, preferentially between 0.5 mol % and 5.0 mol %. In the same way, if the molar ratio (monomer B/[monomer A+monomer B]) of the monomer B, with respect to the combined monomers A and B present in the mixture of stage a), is of between 0.1 mol % and 10.0 mol %, preferably between 0.25 mol % and 7.0 mol %, preferentially between 0.5 mol % and 5.0 mol %, the mixture of stage a) can comprise only the monomers A and B or it can additionally comprise isophthalic acid, so as to adjust the (meta/[meta+para]) molar ratio of the mixture to a precise value of between 0.1 mol % and 10.0 mol %, preferably between 0.25 mol % and 7.0 mol %, preferentially between 0.5 mol % and 5.0 mol %.

According to a preferred embodiment of the invention, the monomer A is bis(2-hydroxyethyl) terephthalate (BHET) and the monomer B is bis(2-hydroxyethyl) isophthalate (BHEI), the R¹ group then being an ethylene —(CH₂—CH₂)— group. Preferably, the BHEI is present in the mixture of stage a) in a molar amount of between 0.01 mol % and 10.00 mol %, preferentially between 0.05 mol % and 7.00 mol %, in a preferred way between 0.05 mol % and 5.00 mol %, with respect to the molar amount of the combined monomers BHET and BHEI present in said mixture of stage a). In this case, the polyester produced by the process according to the invention is a polyethylene terephthalate or PET, advantageously composed of ethylene terephthalate units (substitution of the aromatic nucleus in the para position) and comprising ethylene isophthalate units (substitution of the aromatic nucleus in the meta position). Such a PET advantageously exhibits a degree of crystallization and a melting point which are lower than those of a PET not comprising ethylene isophthalate units. Thus, a PET which comprises ethylene isophthalate units in addition to the ethylene terephthalate units is compatible with packaging applications and in particular with bottle applications, since it is suitable for injection-blow moulding processes and makes it possible to obtain clear and transparent bottles.

Very advantageously, at least one of the monomers A and B can be obtained by processes for the depolymerization of thermoplastic polyesters preferably resulting from collecting and sorting channels (that is to say, resulting from channels belonging to systems for the recycling of waste, in particular plastic waste), in particular in the presence of diol. Very particularly, the mixture of stage a) comprises BHET and BHEI, at least the BHET, preferably the BHET and BHEI, of which result(s) from a process for the treatment of polyester, preferably of PET, comprising the depolymerization of the polyester, preferably comprising PET, in the presence of diol, preferably of ethylene glycol, or in the presence of methanol, in a preferred way in the presence of diol, in particular in the presence of ethylene glycol, said treatment process optionally comprising purification stages so as to obtain a purified BHET or a purified mixture of BHET and BHEI compatible with the polymerization stages of the process according to the invention.

According to a specific embodiment of the invention, the mixture of stage a) can additionally comprise a monomer C of formula 3:

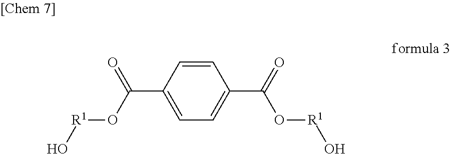

in which:
R³ is chosen from the group consisting of:
the R¹ group,
a —(CH₂)ₙ—(O—(CH₂)ₙ)ₘ— group

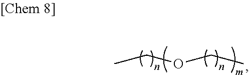

with m and n integers, m being of between 1 and 4, preferably equal to 1 or 2, and n being of between 2 and 4, preferably equal to 2; preferably, the —(CH₂)ₙ—(O—(CH₂)ₙ)ₘ— group is a derivative of diethylene glycol (i.e., —CH₂—CH₂—O—CH₂—CH₂—) or a derivative of triethylene glycol (i.e., —CH₂—CH₂—(O—CH₂—CH₂)₂—),
a —(CH₂—CH(CH₃)₂—CH₂)— group

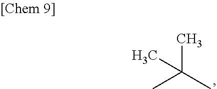

and
a —CH₂—C₆H₁₀—CH₂— group

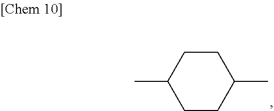

in which —C₆H₁₀— is advantageously a disubstituted cyclohexyl,
R⁴ is chosen from the group consisting of:
a —(CH₂)ₙ—(O—(CH₂)ₙ)ₘ— group, with m and n integers, m being of between 1 and 4, preferably equal to 1 or 2, and n being of between 2 and 4, preferably equal to 2, in a preferred way the —(CH₂)ₙ—(O—(CH₂)ₙ)ₘ— group being a derivative of diethylene glycol, such as —CH₂—CH₂—O—CH₂—CH₂—, or a derivative of triethylene glycol, such as —CH₂—CH₂—(O—CH₂—CH₂)₂—,
a —(CH₂—CH(CH₃)₂—CH₂)— group, and
a —CH₂—C₆H₁₀—CH₂— group, in which —C₆H₁₀— is advantageously a disubstituted cyclohexyl.

Very preferably, R³ is the R¹ group, in particular an ethylene —CH₂—CH₂— group, and R⁴ is a derivative of diethylene glycol, that is to say —CH₂—CH₂—O—CH₂—CH₂—.

In this specific embodiment, the mixture in stage a) comprises the monomer C preferably in a molar ratio of the monomer C, with respect to the combined monomers A and C (monomer C/[monomer A+monomer C]) present in the mixture of stage a), of between 0.05 mol % and 10.00 mol %, preferably between 0.10 mol % and 10.00 mol %, preferentially between 0.25 mol % and 7.00 mol %, in a preferred way between 0.50 mol % and 5.00 mol %.

According to another specific embodiment, the mixture of stage a) can additionally comprise at least one dicarboxylic acid other than isophthalic acid, such as terephthalic acid (PTA), or one of its dialkyl diesters, such as its dimethyl diester, for example dimethyl terephthalate, and/or at least one diol, preferably chosen from ethylene glycol, diethylene glycol, butylene glycol, cyclohexanedimethanol, neopentyl glycol, and their mixtures. Preferably, the mixture of stage a) additionally comprises terephthalic acid (PTA) and optionally at least ethylene glycol.

In this embodiment, the amount of terephthalic acid (PTA) introduced into the mixture of stage a) is such that the molar proportion (meta units/[meta units+para units]) of meta units, in particular contributed by the monomer B and isophthalic acid (IPA), with respect to the combined aromatic units, in particular contributed by the monomer A, PTA, the monomer B, IPA and optionally the monomer C, if it is present in the mixture of stage a), is of preferably between 0.1 mol % and 10.0 mol %, preferentially between 0.25 mol % and 7.0 mol %, in a preferred way between 0.5 mol % and 5.0 mol %.

Advantageously, stage a) is carried out at a temperature of between 15° and 350° C., preferably between 20° and 300° C., in a preferred way between 25° and 285° C., preferably at a pressure between 0.05 and 1.0 MPa, preferably between 0.1 and 0.5 MPa. Very advantageously, stage a) is carried out with a residence time between 0.5 and 10.0 hours, preferably between 1.0 and 6.0 hours, the residence time being defined here as the ratio of the reaction volume of a reactor implemented in stage a) to the flow rate by volume of the liquid stream, comprising the oligomeric intermediate, exiting from said reactor.

A polymerization catalyst, preferably based on antimony, titanium, germanium, aluminium, zinc acetate, calcium acetate and/or manganese acetate, can optionally be introduced in stage a).

The reaction carried out in stage a) generates a diol compound which is advantageously separated during stage a), for example by withdrawing, distillation and/or adsorption. Water can also be formed, in particular when the mixture of stage a), comprising the monomers A and B, and optionally C, additionally comprises a dicarboxylic acid, such as, for example, isophthalic and/or terephthalic acid. The water then formed is itself also advantageously separated during stage a).

Advantageously, the process for the production of a polyester according to the invention comprises a stage b) of polycondensation of the oligomeric intermediate obtained in stage a), it being possible for stage b) to advantageously comprise one or more, preferably one or two, sub-stage(s) of polycondensation, for example at least one, preferably one, sub-stage of liquid-phase or melt-phase polycondensation, optionally followed by at least one, preferably one, sub-stage of solid-phase polycondensation.

Very advantageously, the polycondensation stage b) implements at least one polymerization section, preferably one or two polymerization sections, advantageously operated in the liquid or melt phase, said polymerization section(s) being implemented at a temperature greater than the temperature at which stage a) is carried out, preferably at a temperature of between 19° and 400° C., preferentially between 22° and 350° C., in a preferred way between 265 and 300° C., preferably at a pressure between 0.01 and 100.00 kPa, preferentially between 0.05 and 10.00 kPa, and in a preferred way with a residence time of between 0.1 and 5.0 hours, preferably between 0.5 and 4 hours, preferentially between 1.0 and 3.0 hours. According to the invention, the residence time in the polymerization section of stage b) is defined as the ratio of the reaction volume of a reactor implemented in said polymerization section to the flow rate by volume of the liquid stream, comprising the polyester produced, exiting from said reactor.

The polymerization reaction can optionally be continued in a polycondensation section located downstream of the polymerization section and operated in the solid phase, preferably at a temperature (in particular a product temperature) of between 19° and 250° C., preferentially between 20° and 230° C. Depending on whether this operation is carried out continuously or batchwise, the polycondensation section can preferably be operated under an inert atmosphere, for example under a nitrogen stream, at a pressure close to atmospheric pressure, or under vacuum (in particular at a pressure between 0.01 and 100 kPa, indeed even between 0.01 and 10 kPa). The residence time (defined as the time during which the product is subjected to the polycondensation conditions in said polycondensation section) is of between 5 and 20 hours, preferably between 10 and 16 hours. Said polycondensation section can advantageously be preceded by a crystallization section, thus located between the polymerization section and the polycondensation section, in which the polyester formed, obtained at the end of the polymerization section, is advantageously crystallized, it being possible for said crystallization section to be operated at a temperature preferably between 110 and 210° C. and for a residence time (defined as the time during which the product is subjected to the crystallization conditions in said section) preferably between 0.5 and 6 hours.

Stage b) is preferably carried out in the presence of a polymerization catalyst, in particular based on antimony, titanium, germanium, aluminium, zinc acetate, calcium acetate and/or manganese acetate.

Additives can be introduced in the polycondensation stage b). The additives optionally introduced in stage b) can, for example, be: agents which inhibit the etherification side reactions, such as, for example, amines (n-butylamine, diisopropylamine or triethylamine), sodium hydroxide or organic hydroxides or lithium carbonate, stabilizing agents, such as phosphites or phosphates, and compounds of polyamide type for reducing the amount of decomposition product, such as acetaldehyde.

The process according to the invention thus makes it possible to obtain a polyester, advantageously having a content of meta units between 0.1 mol % and 10.0 mol %, preferably between 0.25 mol % and 7.0 mol %, preferentially between 0.5 mol % and 5.0 mol %, with respect to the combined elementary units of the polyester obtained, which makes it possible for the polyester obtained to exhibit a decreased degree of crystallization and a decreased melting point while retaining satisfactory mechanical properties or at the least mechanical properties suitable for injection moulding and/or injection-blow moulding processes, which thus renders it compatible with packaging applications and more particularly with applications of bottle type. In particular, the process according to the invention can be incorporated in channels for recycling plastic waste, since it can advantageously use monomers resulting from the depolymerization of polyesters to prepare the targeted polyester in a simple way.

The following examples illustrate the invention without limiting the scope thereof.

### EXAMPLES

### Example 1 (according to the Invention)

A mixture of BHET and BHEI such that BHEI/[BHET+BHEI]=2.2+/−0.1 mol % is involved in an esterification stage a) carried out at 275° C. under 0.15 MPa in the presence of 250 ppm of Sb₂O₃ catalyst over 99 minutes.

The reaction medium is subsequently subjected, in a first polycondensation stage, to a temperature of 285° C. and a pressure of 0.1 kPa for 105 min.

The polyester obtained at the end of this first polycondensation stage exhibits a proportion of meta units, with respect to the combined aromatic units, of 2.2+/−0.1 mol %.

Subsequently, after a preliminary stage of crystallization for 2 h at 125° C. (that is to say, at the temperature of the granules), the preceding polyester obtained at the end of the first polycondensation stage is involved in a solid-phase polycondensation stage at 200° C., at atmospheric pressure under nitrogen circulation.

The polyester obtained at the end of the second polycondensation stage has a proportion of meta units, with respect to the combined aromatic units, of 2.2+/−0.1 mol %, which is entirely compatible with packaging applications, in particular applications of bottle type.

### Example 2 (not in Accordance with the Invention)

A mixture of BHET and BHEI such that BHEI/[BHET+BHEI]=0.2 mol % is involved in an esterification stage a) carried out at 275° C. under 0.15 MPa in the presence of 250 ppm of Sb₂O₃ catalyst over 75 minutes.

The reaction medium is subsequently subjected, in a first polycondensation stage, to a temperature of 285° C. and a pressure of 0.1 kPa for 120 min.

The polyester obtained at the end of this first polycondensation stage exhibits a proportion of meta units, with respect to the combined aromatic units, of 0.2 mol %.

Subsequently, after a preliminary stage of crystallization for 2 h at 125° C. (that is to say, at the temperature of the granules), the preceding polyester obtained at the end of the first polycondensation stage is involved in a solid-phase polycondensation stage at 205° C., at atmospheric pressure under nitrogen circulation.

The polyester obtained at the end of the second polycondensation stage has a proportion of meta units, with respect to the combined aromatic units, of 0.2 mol %, which is a low proportion, not very compatible with packaging applications, in particular applications of bottle type.

### Example 3 (According to the Invention)

A mixture of BHET and BHEI such that BHEI/[BHET+BHEI]=0.2 mol % is involved in an esterification stage a) carried out at 275° C. under 0.15 MPa over 86 minutes in the presence of 250 ppm of Sb₂O₃ catalyst and of IPA such that (BHEI+IPA)/(BHEI+IPA+BHET)=2.3 mol %.

The reaction medium is subsequently subjected, in a first polycondensation stage, to a temperature of 285° C. and a pressure of 0.1 kPa for 73 min.

The polyester obtained at the end of this first polycondensation stage exhibits a proportion of meta units, with respect to the combined aromatic units, of 2.3 mol %.

Subsequently, after a preliminary stage of crystallization for 2 h at 125° C. (that is to say, at the temperature of the granules), the preceding polyester obtained at the end of the first polycondensation stage is involved in a solid-phase polycondensation stage at 205° C., at atmospheric pressure under nitrogen circulation.

The polyester obtained at the end of the second polycondensation stage has a proportion of meta units, with respect to the combined aromatic units, of 2.3 mol %, which is entirely compatible with packaging applications.

1. A process for the production of a polyester, comprising:
a) a stage of esterification of a mixture comprising a monomer A of formula 1 and a monomer B of formula 2 or a monomer A of formula 1, a monomer B of formula 2 and isophthalic acid, in order to obtain an oligomeric intermediate, 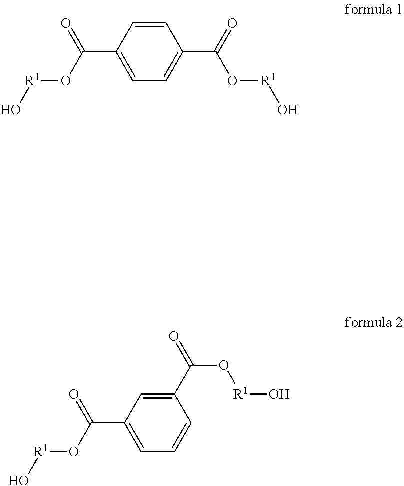
in which R¹ is chosen from the group consisting of:
—(CH₂)ₙ—, with n an integer of between 2 and 4,
—(CH₂—CHR²)—, with R² chosen from linear or branched alkyl groups comprising between 1 and 6 carbon atoms (C₁-C₆) and a phenyl group, and
b) a stage of polycondensation of the oligomeric intermediate.

2. The process according to claim 1, in which the mixture of stage a) comprises the monomer A and the monomer B or the monomer A, the monomer B and isophthalic acid in a molar ratio (meta/[meta+para]) of the meta units, with respect to the combined aromatic units present in the mixture, of between 0.1 mol % and 10.0 mol %.

3. The process according to claim 1, in which R¹ is an ethylene group.

4. The process according to claim 1, in which the mixture of stage a) comprises a monomer C of formula 3: 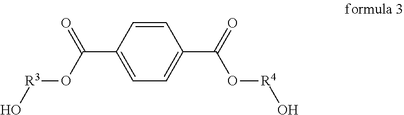
in which:
R³ is chosen from the group consisting of:
the R¹ group,
a —(CH₂)ₙ—(O—(CH₂)ₙ)ₘ— group, with m and n integers, m being of between 1 and 4, preferably equal to 1 or 2, and n being of between 2 and 4, preferably equal to 2,
a —(CH₂—CH(CH₃)₂—CH₂)— group, and
a —CH₂—C₆H₁₀—CH₂— group,
R⁴ is chosen from the group consisting of:
a —(CH₂)ₙ—(O—(CH₂)ₙ)ₘ— group, with m and n integers, m being of between 1 and 4, preferably equal to 1 or 2, and n being of between 2 and 4, preferably equal to 2,
a —(CH₂—CH(CH₃)₂—CH₂)— group, and
a —CH₂—C₆H₁₀—CH₂— group.

5. The process according to claim 4, in which the mixture of stage a) comprises the monomer C present in a molar ratio of the monomer C, with respect to the combined monomers A and C present in the mixture of stage a), of between 0.05 mol % and 10.00 mol %.

6. The process according to claim 1, in which the mixture of stage a) comprises a dicarboxylic acid other than isophthalic acid, such as terephthalic acid, or one of its dialkyl diesters, such as its dimethyl diester, for example dimethyl terephthalate, and/or at least one diol, preferably chosen from ethylene glycol, diethylene glycol, butylene glycol, cyclohexanedimethanol, neopentyl glycol or their mixtures, the preferred diol being ethylene glycol.

7. The process according to claim 1, in which stage a) is carried out at a temperature of between 15° and 350° C.

8. The process according to claim 1, in which stage a) is carried out at a pressure between 0.05 and 1.0 MPa.

9. The process according to claim 1, in which stage b) comprises one or more polycondensation sub-stage(s), for example at least one sub-stage of liquid-phase or melt-phase polycondensation, optionally followed by at least one sub-stage of solid-phase polycondensation.

10. The process according to claim 1, in which stage b) implements at least one polymerization section, operated in the liquid or melt phase, at a temperature greater than the temperature at which stage a) is carried out, preferably at a temperature of between 19° and 400° C., preferentially between 22° and 350° C., in a preferred way between 265 and 300° C., and preferably at a pressure between 0.01 and 100.00 kPa, preferably between 0.05 and 10.00 kPa.

11. The process according to claim 1, in which stage b) is carried out in the presence of a polymerization catalyst, preferably based on antimony, titanium, germanium, aluminum, zinc acetate, calcium acetate and/or manganese acetate.

12. The process according to claim 1, in which the mixture of stage a) comprises the monomer A and the monomer B or the monomer A, the monomer B and isophthalic acid in a molar ratio (meta/[meta+para]) of the meta units, with respect to the combined aromatic units present in the mixture, of between 0.25 mol % and 7.0 mol %.

13. Process according to claim 1, in which the mixture of stage a) comprises the monomer A and the monomer B or the monomer A, the monomer B and isophthalic acid in a molar ratio (meta/[meta+para]) of the meta units, with respect to the combined aromatic units present in the mixture, of between 0.5 mol % and 5.0 mol %.

14. The process according to claim 4, in which the mixture of stage a) comprises the monomer C present in a molar ratio of the monomer C, with respect to the combined monomers A and C present in the mixture of stage a), of between 0.10 mol % and 10.00 mol %.

15. The process according to claim 4, in which the mixture of stage a) comprises the monomer C present in a molar ratio of the monomer C, with respect to the combined monomers A and C present in the mixture of stage a), of between 0.25 mol % and 7.00 mol %.

16. The process according to claim 4, in which the mixture of stage a) comprises the monomer C present in a molar ratio of the monomer C, with respect to the combined monomers A and C present in the mixture of stage a), of between 0.50 mol % and 5.00 mol %.

17. The process according to claim 1, in which stage a) is carried out at a temperature of between 20° and 300° C.

18. The process according to claim 1, in which stage a) is carried out at a temperature of between 25° and 285° C.

19. The process according to claim 1, in which stage a) is carried out at a pressure between 0.1 and 0.5 MPa.
